(19) United States
(12) Patent Application Publication
(10) Pub. No.: US 2006/0095800 A1
(43) Pub. Date: May 4, 2006

(54) Electronic apparatus and method for controlling electric power consumption of the electronic apparatus

(75) Inventor: Rinzo Iwamoto, Nishitama-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/258,865

(22) Filed: Oct. 27, 2005

(30) Foreign Application Priority Data
Oct. 29, 2004 (JP) 2004-316845

(51) Int. Cl. G06F 1/26

(52) U.S. Cl. 713/300

(57) ABSTRACT

A PDA can perform a wide variety of electric power consumption control performances of turning off a display unit, dimming a light source, lowering definition of image in video reproduction processing by a decoding calculation processing unit, and an electric power consumption control unit includes an electric power consumption setup unit for setting up the manner of operating the performances for each kind of programs. Furthermore, the electric power consumption control unit includes a content kind detection unit for determining the kind of an on-air program received through a tuner, and controls respective units such that the electric power consumption setup unit can perform power saving function set up for each kind of programs based on the determination result of the content kind detection unit.

### CROSS-REFERENCE TO RELATED APPLICATIONS

This application is based upon and claims the benefit of priority from prior Japanese Patent Application No. 2004-316845, filed Oct. 29, 2004, the entire contents of which are incorporated herein by reference.

### BACKGROUND

1. Field

The present invention relates to a technique of controlling electric power consumption that is desirably applied to an electronic apparatus referred to as a PDA (personal digital assistant) etc. which can be driven by a battery.

2. Description of the Related Art

In recent years, small-sized portable electronic apparatuses are coming to have multiple functions and high functions, and electronic apparatuses having the television function of receiving and presenting television broadcasting are coming into wide use. Since this type of portable electronic apparatuses are driven by electric power from a battery, the power saving function for suppressing amount of electric power consumption as much as possible is very important.

As a power saving function concerning the television function, there is suggested a method of reducing electric power consumption during commercials or commercial-cutting picture recording, in which picture recording is stopped during commercials when recording television programs (for example, refer to Jpn. Pat. Appln. KOKAI Publication No. 2000-236502 etc.)

In addition to the commercial-cutting picture recording, there is a strong demand of controlling the performance of power saving function depending on the kind of programs when watching on-air programs. That is, for example, there are some persons who want to watch movies and dramas with high-definition, and do not care even if news and sports are aired with low-definition and want to suppress amount of electric power consumption accordingly.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a perspective view of an electronic apparatus (PDA) of one embodiment according to the present invention;

FIG. 2 shows a block diagram indicative of the system configuration of the PDA in this embodiment;

FIG. 3 shows a diagram for explaining the concept of electric power consumption control that the PDA in this embodiment performs;

FIG. 4 shows a diagram indicative of the configuration of one program table data that the PDA in this embodiment acquires;

FIG. 5 shows a diagram indicative of an example of an electric power consumption setting screen that the PDA in this embodiment presents;

FIG. 6 shows a diagram indicative of an applied example of an electric power consumption setting screen that the PDA in this embodiment presents; and

FIG. 7 shows a flowchart indicative of the procedure of controlling electric power consumption control performance related with the television function carried out by the PDA in this embodiment.

### DETAILED DESCRIPTION

The present invention will further be described below with reference to the accompanying drawings.

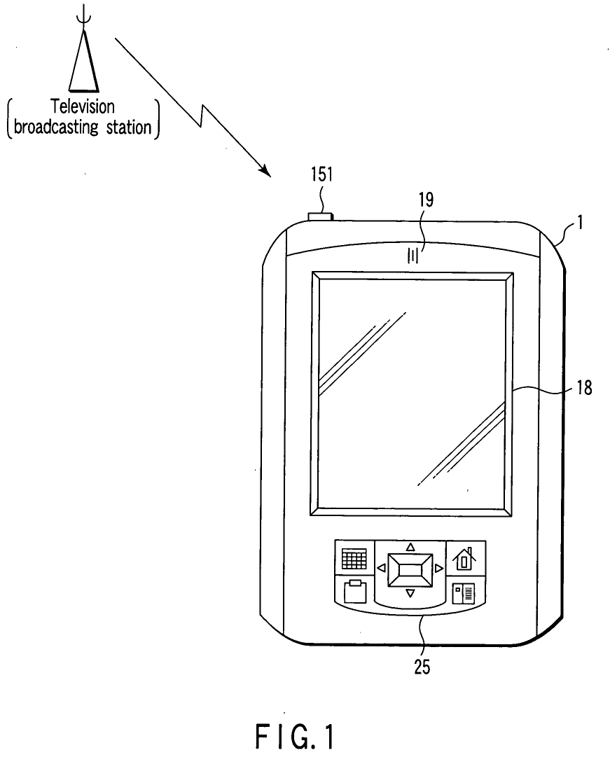

FIG. 1 shows a perspective view of an electronic apparatus of one embodiment according to the present invention. In this embodiment, the electronic apparatus is realized as a PDA.

The PDA 1 is an electronic apparatus provided with the television function of receiving and presenting television broadcasting, which can be driven by a battery, and has a thin housing in the shape of a box, as shown in FIG. 1. The housing has on the peripheral wall thereof an antenna 151 for receiving television broadcasting, a display unit 18 for displaying various output data including video data of television broadcasting, a speaker 19 for audio-outputting various output data including audio data of television broadcasting, an operation key 25 for performing data input and performance instruction, and the like.

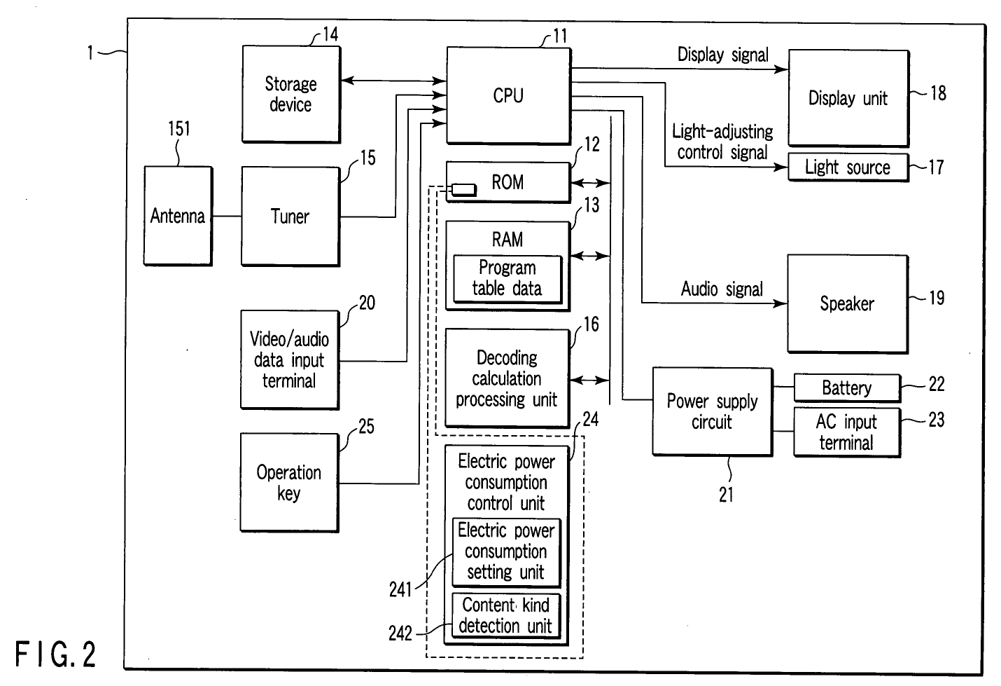

FIG. 2 shows a block diagram indicative of the system configuration of the PDA 1. As shown in FIG. 2, the PDA 1 includes above-described antenna 151, display unit 18, speaker 19, operation key 25, and further includes a CPU 11, a ROM 12, a RAM 13, a storage device 14, a tuner 15, a decoding calculation processing unit 16, a light source 17, a video/audio data input terminal 20, a power supply circuit 21, a battery 22, an AC input terminal 23, an electric power consumption control unit 24, etc.

The CPU 11 is an processing device for controlling the entire performance of the PDA 1, and executes various programs stored in the ROM 12. As programs stored in the ROM 12, in addition to a basic system or operating system, there are various items of application software for providing above-described television function, document forming function, spreadsheet function, etc. The electric power consumption control unit 24 is configured when electric power consumption control utility software stored in the ROM 12 is executed by the CPU 11.

The RAM 13 is a storage medium working as a main storage device of the PDA 1 which is used as a work area when the CPU 11 executes these programs. On the other hand, the storage device 14 is a storage medium working as an auxiliary storage device of the RAM 13 which stores massive various data.

The tuner 15 is a tuning device for receiving an electric wave of a desired channel among plural channels through the antenna 151. Program data (video data including audio data) of television broadcasting carried by an electric wave received by the tuner 15 is an encoded digital signal, and the program data or the digital signal is supplied to the decoding calculation processing unit 16 where video data and audio data are reproduced respectively. Decoded video data is output to be displayed as images by the display unit 18 that is illuminated by the light source 17, while decoded audio data is output as sounds by the speaker 19. The decoding calculation processing unit 16 is a decoder circuit that decodes a digital signal encoded under the MPEG 4 system etc. to an analog signal, and may be established as software to be executed by the CPU 11. Furthermore, program table data (metadata) having written therein broadcasting schedule of respective channels and attribution of respective programs can be acquired as needed through the tuner 15. The program table data, which is output at any time from a particular broadcasting station etc., is acquired at the time of starting utilization of the television function or the power source is turned on to be stored in the RAM 13.

The television function of the PDA 1 can record and reproduce television broadcasting, and when recording television broadcasting, digitalized program data is stored in the storage device 14 as a file without being decoded. When reproducing television broadcasting, program data stored in the storage device 14 as a file is read out to be supplied to the decoding calculation processing unit 16. Furthermore, the television function receives video data including audio data from the video/audio data input terminal 20 and supplies thus received data to the decoding calculation processing unit 16, which makes it possible to watch external video data using the display unit 18 and speaker 19.

The power supply circuit 21 controls supply of electric power to the respective units in the PDA 1, and is connected to the battery 22 and to the AC input terminal 23. The battery 22 is a secondary battery which can be charged and discharged repeatedly, and basically the power supply circuit 21 distributes electric power from the battery 22 to the respective units. In case an AC power source is input through the AC input terminal 23, the power supply circuit 21 distributes electric power from the AC power source to the respective units, while charges the battery 22 using the electric power. The electric power consumption control unit 24 is operated to reduce amount of electric power consumption as much as possible when electric power from the battery 22 is distributed to the respective units, and includes an electric power consumption setting unit 241 for making a user arbitrarily set up the manner of operating the electric power consumption control function, and a content kind detection unit 242 for determining attribution value including the kind of a program being watched. The principle of performance of the electric power consumption control unit 24 will be explained later.

When some sort of key operation is carried out, the operation key 25 notifies the CPU 11 of the operation as an interrupt. By this notification, the CPU 11 can make the PDA 1 carry out performance conforming to the instruction of a user.

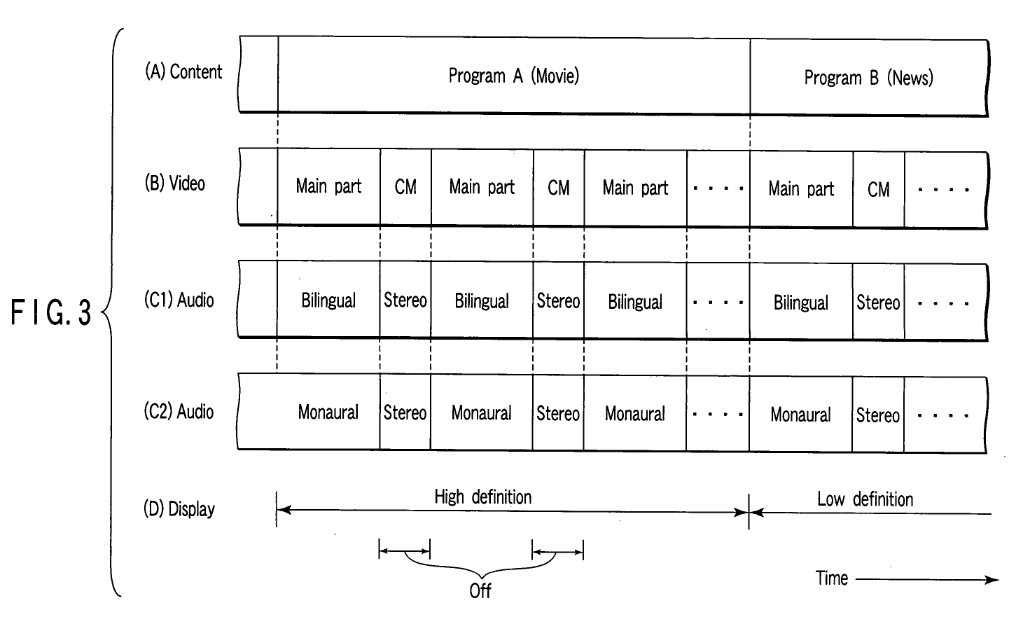

Next, with reference to FIG. 3, the concept of electric power consumption control that the PDA 1 performs using the electric power consumption control unit 24 will be explained. So as to simplify the explanation, as the case to reduce amount of electric power consumption, a case in which definition of image is lowered (calculation processing amount is reduced) when video data is reproduced by the decoding calculation processing unit 16, and a case in which video is made off during commercials (electricity consumption by the light source 17 and display unit 18 is suppressed) will be considered.

It is assumed that, on a certain channel, a program A is just about to start and a program B will start subsequently ((A) of FIG. 3). The program A is a “movie”, while the program B is “news”. The user of the PDA 1 who watches these programs on this channel considers that the “movie” should be of high-definition, and the “news” may be of low-definition, and furthermore, commercials during the “movie” are not necessary. In this case, the electric power consumption control unit 24 refers to separately acquired program table data, and firstly judges the kind of an on-air program. In case the program is “news”, the electric power consumption control unit 24 reduces amount of electric power consumption by making the definition of image low. Then, secondly, in case the program is “movie”, the electric power consumption control unit 24 searches the air time of commercials, and reduces amount of electric power consumption by making video off during air time of respective commercials ((B) of FIG. 3B, (D) of FIG. 3).

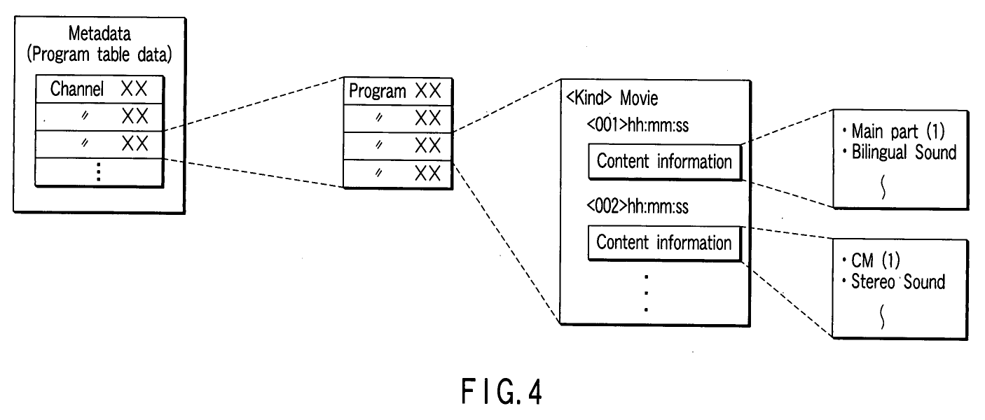

FIG. 4 shows a diagram indicative of the configuration of one program table data acquired through the tuner 15. This program table data is configured as a file having the hierarchical structure shown in FIG. 4 by the XML (extensible markup language) that can define various meaning using a tag.

In the program table data, programs for each day and for each channel are enumerated in the order of broadcasting, and the kind of program, a detailed time schedule of main parts and commercials, etc. are written for each program. The content kind detection unit 242 determines attribution value including the kind of each program by referring to the program table data. Then, receiving the result, the electric power consumption control unit 24 can send an instruction of lowering definition of image to the decoding calculation processing unit 16 according to need. Furthermore, the electric power consumption control unit 24 can send an instruction of turning off the power source to the light source 17 and display unit 18 according to need. In this embodiment, “according to need” in the former (instruction of lowering definition of image to the decoding calculation processing unit 16) is the case in which the kind is “news”, while “according to need” in the latter (instruction of turning off the power source to the light source 17 and display unit 18) is the case in which on-air content is “commercial”.

In the example shown in FIG. 4, attribution and attribution value that can determine whether on-air content is main part or commercial are arranged in the program table data. On the other hand, in case attribution and attribution value necessary for the determination are not arranged, the following method can be employed for the determination.

It is assumed that the kind of audio data is different, that is, audio data of main parts is “bilingual”, while audio data of commercials is “stereo”, as shown in (C1) of FIG. 3. Utilizing the difference, the content kind detection unit 242 can determine whether on-air content is main part or commercial by retrieving attribution having attribution value indicative of the kind of audio data in the program table data, and referring to the attribution value owned by the attribution. Furthermore, in case the kind of audio data is different, that is, audio data of main parts is “monaural”, while audio data of commercials is “stereo” as shown in (C2) of FIG. 3, the determination can be performed in a similar procedure. Moreover, in case of utilizing the difference of audio data, the determination can be carried out by inquiring the decoding calculation processing unit 16 that reproduces sounds, in which case the program table data is not utilized.

In this embodiment, an example in which the program table data is configured such that broadcasting schedule of respective channels is included. On the other hand, for example, in case metadata of respective programs is output along with on-air video data, in addition to the time when starting utilization of the television function or time when turning on the power source, at the time of changing the channel or at the time of changing the program, respective metadata may be acquired to be stored in the RAM 13.

FIG. 5 shows a diagram indicative of an example of an electric power consumption setting screen that the electric power consumption setting unit 241 presents. As shown in FIG. 5, in the electric power consumption setting screen, electric power consumption control items are arranged in the vertical axis direction, and program (content) kinds are arranged in the horizontal axis direction, and the user can set up the performance of the electric power consumption control items for each kind, respectively. When the field of “video off” is checked, the light source 17 and display unit 18 are turned off, and video reproduction processing by the decoding calculation processing unit 16 is stopped (audio reproduction processing is continued). In the example shown in FIG. 5, when watching a “music” program, the displaying screen comes to be blacked out. When the field of “video off” is checked, “dimming display unit”, “lowering definition of image”, and “cutting commercial” to be described later are removed from setup items automatically. Controlling the light source 17 and display unit 18 is performed through a control signal line led out from the CPU 11, while controlling the decoding calculation processing unit 16 is performed by communication by way of a bus arranged in the PDA 1.

When the field of “dimming display unit” is checked, the light source 17 is dimmed. In the example shown in FIG. 5, when watching a “news” program, the displaying screen comes to be somewhat dimmed. When the field of “lowering definition of image” is checked, video reproduction processing by the decoding calculation processing unit 16 is carried out with low definition of image. In the example shown in FIG. 5, when watching a “news” program or “sports” program, definition of image comes to be lowered.

When the field of “cutting commercial” is checked, during commercials, the light source 17 and display unit 18 are turned off similar to the case of “video off”. In the example shown in FIG. 5, when watching a “sports” program or “movie” program, the displaying screen comes to be blacked out (during commercials). When the field of “audio off” is checked, the speaker 19 is muted. In the example shown in FIG. 5, when watching a “sports” program, sounds come to be killed. Controlling the speaker 19 is performed through a control signal line led out from the CPU 11.

That is, in the electric power consumption setting screen, the user can set up such that individual electric power consumption control performance is carried out for a “news” program, “music” program, “sports” program, and “movie” program, respectively, in the following manner.
“news” program: the light source 17 is dimmed, and video reproduction processing by the decoding calculation processing unit 16 is carried out with low difinition of image.
“music” program: the light source 17 and display unit 18 are made off at any time.
“sports” program: video reproduction processing by the decoding calculation processing unit 16 is carried out with low definition of image, and the light source 17 and display unit 18 are made off during commercials alone, and audio is made off at any time.
“movie” program: the light source 17 and display unit 18 are made off during commercials alone.

In this way, in the PDA 1, various electric power consumption control performances can be set up and carried out depending on the demand of the user. The electric power consumption control items shown in FIG. 5 are examples, to which the present invention is not restricted, and any electric power consumption control item can be applied as an option. For example, instead of video reproduction processing by the decoding calculation processing unit 16 with low definition of image, amount of calculation processing may be reduced by skipping frames to be reproduced by a certain number per unit time (frame skipping), or this frame skipping may be performed together with lowering definition of image.

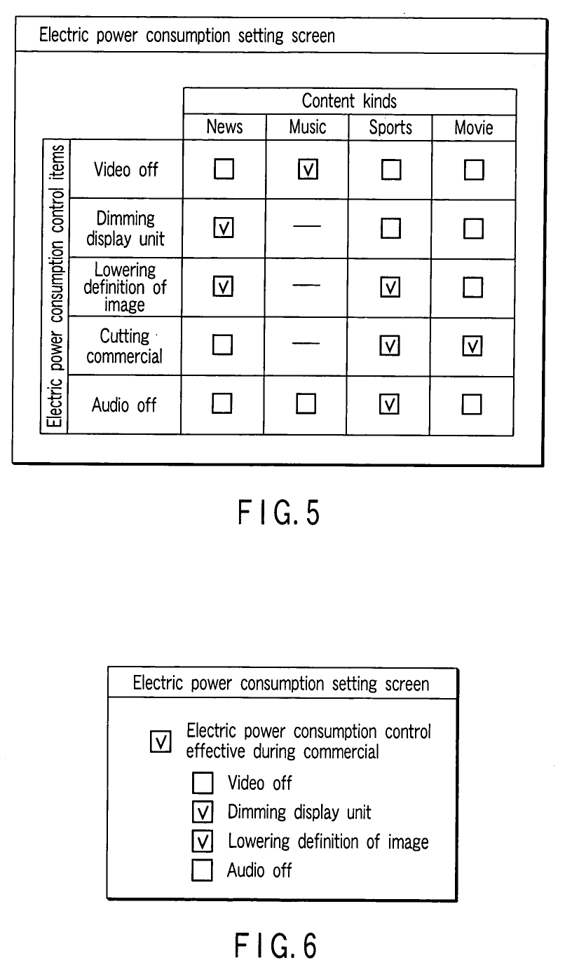

FIG. 6 shows a diagram indicative of an applied example of an electric power consumption setting screen that the electric power consumption setting unit 241 presents. In this example, electric power consumption control performance during commercials can be set up regardless of the kind of programs, and at first, the electric power consumption control performance during commercials is set up with a check box of “electric power consumption control effective during commercial”.

When electric power consumption control performance during commercials is made effective, the respective check boxes of above-described “video off”, “dimming display unit”, “lowering definition of image”, and “audio off” become selectable, and the user checks check boxes of desired electric power consumption control items among them. In the example shown in FIG. 6, check box of “electric power consumption control effective during commercial” is checked as well as check boxes of “dimming display unit” and “lowering definition of image” are checked. Accordingly, during commercials, the light source 17 is dimmed, and video reproduction processing by the decoding calculation processing unit 16 is carried out with low definition of image. On the other hand, some users consider that commerecials are not necessary at all, and some users consider that commercial is one information source. Thus, some users can perform a broad range of electric power consumption control meeting with the respective users'needs by not reducing electric power consumption employing a uniform method of turning off the power source of the display unit during commercials but reducing electric power consumption employing another method of lowering definition of image during commercials alone.

The electric power consumption setting screen is not restricted to those shown in FIG. 5 and FIG. 6, and electric power consumption setting screens under various and multiple combinations can be configured when having a scheme of controlling the electric power consumption control performance based on attribution value including the kind of programs being aired.

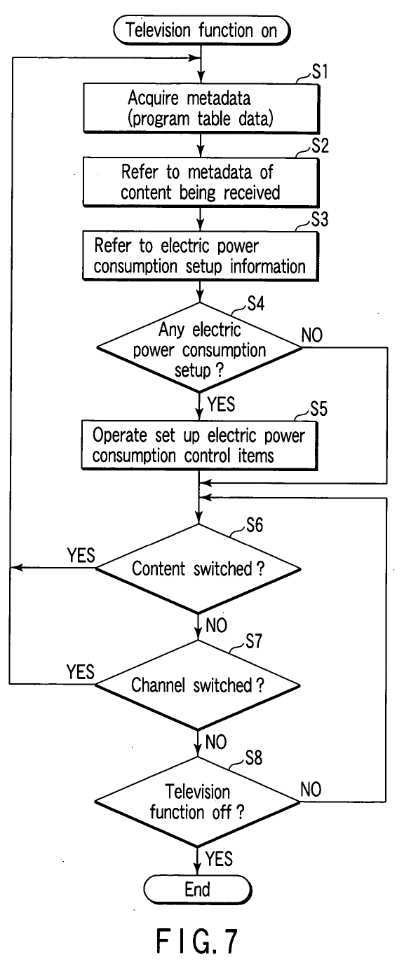

FIG. 7 shows a flow chart indicative of the procedure of controlling the electric power consumption control performance related with the television function to be carried out by the PDA 1. In this embodiment, it is assumed that program table data is configured for each program unit.

For example, when the utilization of the television function is started, the electric power consumption control unit 24 acquires program table data under this timing (Step S1). Then, the electric power consumption control unit 24 refers to thus acquired program table data (Step S2), and refers to electric power consumption setup information at this time (Step S3).

In case electric power consumption setup of some kind has been performed concerning attribution shown in the program table data (Step S4, Yes), the electric power consumption control unit 24 controls to operate thus set up electric power consumption control item (Step S5).

Then, the electric power consumption control unit 24 examines whether or not program is switched (Step S6), or whether or not channel is switched (Step S7), and in case either of which occurs (Yes in Step S6, Yes in Step S7), the processing from Step S1 is repeated. Then, in case the television function is turned off (Step S8, Yes), the processing is ended.

In this way, the PDA 1 can control the operation of power saving function when watching programs being aired arbitrarily depending on attribution of respective programs.

On the other hand, as has been described above, in addition to receiving and presenting programs being aired through the tuner 15, the television function of the PDA 1 can perform recording and reproducing processing using the storage device 14, and can make it possible to watch external video data input through the video/audio data input terminal 20. Furthermore, above-described electric power consumption performance control based on attribution of respective programs can be naturally employed when reproducing video data recorded using the storage device 14 or when reproducing video data input from outside.

Furthermore, being applied in various ways in addition to the electric power consumption performance control, the control operation based on attribution of respective programs can be applied not only to a PDA or notebook-sized personal computer driven by a battery but also to a stationary television receiver driven by electric power from an AC power source. In this case, since an environment that is always connected to the network can be established, it becomes possible to acquire program table data from a certain Web server through the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus having input unit configured to input video data, comprising:
a display unit which displays video data input by the input unit; and
a control unit configured to control amount of electric power consumption of the electronic apparatus depending on the kind of video data displayed on the display unit.

2. The electronic apparatus according to claim 1, further comprising a setup unit configured to set up control content of the control unit for each kind of the video data,
wherein the control unit controls amount of electric power consumption of the electronic apparatus based on the control content set up by the setup unit.

3. The electronic apparatus according to claim 1, wherein the control unit controls amount of electric power consumption of the electronic apparatus based on attribution value related with the video data.

4. The electronic apparatus according to claim 1, wherein the control unit turns off a power source of the display unit.

5. The electronic apparatus according to claim 1, wherein the control unit turns off or dims a light source of the display unit for displaying the video data.

6. The electronic apparatus according to claim 1, wherein the control unit mutes or reduces sounds related with the video data.

7. The electronic apparatus according to claim 1, wherein the control unit stops decoding processing for decoding the video data or lowers definition of image.

8. The electronic apparatus according to claim 1, wherein the control unit stops display of the video data or skips frames.

9. An electronic apparatus having a tuner which receives broadcasting data, comprising:
a display unit which displays broadcasting data input by the tuner; and
a control unit configured to control amount of electric power consumption of the electronic apparatus depending on the kind of broadcasting data displayed on the display unit.

10. The electronic apparatus according to claim 9, wherein the control unit reduces amount of electric power consumption of the electronic apparatus in case commercial messages are displayed on the display unit.

11. The electronic apparatus according to claim 9, further comprising setup unit configured to set up control content of the control unit for each kind of the broadcasting data,
wherein the control unit controls amount of electric power consumption of the electronic apparatus based on the control content set up by the setup unit.

12. A method for controlling electric power consumption of an electronic apparatus having a display unit which displays video data, comprising:
inputting video data; and
controlling, after the inputting, amount of electric power consumption of the electronic apparatus depending on the kind of video data displayed on the display unit.

13. The method for controlling electric power consumption according to claim 12, further comprising setting up control content of amount of electric power consumption of the electronic apparatus for each kind of the video data,
wherein the controlling controls amount of electric power consumption of the electronic apparatus based on the set up control content for amount of electric power consumption of the electronic apparatus.

14. The method for controlling electric power consumption according to claim 12, wherein the controlling controls amount of electric power consumption of the electronic apparatus based on attribution value related with the input video data.

15. The method for controlling electric power consumption according to claim 12, wherein the controlling turns off a power source of the display unit in order to reduce amount of electric power consumption of the electronic apparatus.

16. The method for controlling electric power consumption according to claim 12, wherein the controlling turns off or dims a light source of the display unit in order to reduce amount of electric power consumption of the electronic apparatus.
